(19) United States
(12) Patent Application Publication
(10) Pub. No.: US 2013/0077674 A1
(43) Pub. Date: Mar. 28, 2013

(54) METHOD AND APPARATUS FOR ENCODING MOVING PICTURE

(71) Applicant: Jaewoo KIM, Seoul (KR)

(72) Inventor: Jaewoo KIM, Seoul (KR)

(73) Assignee: MEDIA EXCEL KOREA CO. LTD., Seoul (KR)

(21) Appl. No.: 13/242,339

(22) Filed: Sep. 23, 2011

(51) Int. Cl. H04N 7/26

(52) U.S. Cl. 375/240.03; 375/240.26; 375/E07.2; 375/E07.139

(57) ABSTRACT

A method and apparatus for encoding a moving picture. The apparatus may encode video data with high resolution in parallel without requiring communication between processors that are complex and are sensitive to time.

### BACKGROUND OF THE INVENTION

1. Field of the Invention

The present invention relates to a method and apparatus for encoding a moving picture.

2. Description of the Related Art

In general, since video data is larger in size than text data or audio data, the video data needs to be compressed when being stored or transmitted. A video codec is a device for compressing and decompressing video data. Video codecs satisfying various standards such as MPEG-1, MPEG-2, H.263, and H.264/MPEG-4 are widely used.

From among the standards, since the H.264 standard provides an excellent compression ratio and image quality, the H.264 standard is used in various fields including mobile television (TV), the Internet, web TV, and cable TV. However, since the H.264 standard is very complex compared to the MPEG-4 standard, it is difficult to implement an H.264 codec by using a single central processing unit (CPU) or a single core processor.

In this case, it may be considered that the H.264 codec is processed in parallel by using a plurality of processors or a plurality of CPUs. However, when a plurality of CPUs are used by limited resources, it is difficult to encode video with high resolution. For examples, since CPUs communicate with each other so that a single CPU processes a portion of an image and CPUs complete a single video frame, the CPUs require communicating abilities therebetween. However, since communication between CPUs is complex, there is a limit in using the H.264 codec or it is difficult to use the H.264 codec and it is difficult to support video with high resolution.

### SUMMARY OF THE INVENTION

The present invention provides a method and apparatus for encoding a moving picture, which encode video data with high resolution in parallel without requiring communication between processors that are complex and are sensitive to time.

The present invention also provides a method and apparatus for encoding a moving picture, by which first pass encoding is performed by performing simple encoding, but not by performing a complete encoding process while second pass encoding is performed by using a sliding window method, thereby adjusting a bit rate according to complexity of an image.

According to an aspect of the present invention, there is provided an apparatus for encoding a moving picture, the apparatus including a first pass encoder for performing first pass encoding on an input video image; and a second pass encoder comprising first through Nth processors (where N is a positive integer equal to or greater than 2) for receiving first through Nth groups of picture (GOPs) from the first pass encoder and for encoding the first through Nth GOPs, respectively, wherein the first through Nth processors perform encoding at a 1/N speed and transmit results obtained by encoding the first through Nth GOPs as feedback to the first pass encoder, respectively.

The first pass encoder may transmit each GOP of the first GOP through Nth GOP and a target bit of each frame to the first through Nth processors.

A target quantization parameter (QP) of an initial I frame of each GOP of the first GOP through Nth GOP may be transmitted to the first through Nth processors.

A target buffer level of the first GOP through Nth GOP may be transmitted to the first through Nth processors.

The apparatus may further include a serialization unit for generating encoding streams obtained by encoding the first GOP through Nth GOP as a single stream.

The first pass encoder may further include buffers for storing delayed encoding results that are transmitted from the first through Nth processors.

The first through Nth processors may perform encoding in parallel on the first through Nth GOPs at the 1/N speed.

The first pass encoder or the second pass encoder may perform encoding while moving sliding windows within a range of each of the first GOP through Nth GOP.

The first pass encoder may calculate complexity of a YUV image of the input video image, calculates a target bit and a target quantization parameter (QP) by using the complexity, and transmits the calculated complexity, the target bit, and the target QP to the second pass encoder.

The second pass encoder may perform encoding by using the complexity, the target bit, and the target QP, which are transmitted from the first pass encoder, and transmits complexity, an actually used bit, and an actual QP, which are calculated according to the encoding result, as feedback to the first pass encoder.

The first pass encoder may compensate the complexity, the target bit, and the target QP by using the complexity, the actually used bit, and the actual QP, which are transmitted as feedback from the second pass encoder.

According to another aspect of the present invention, there is provided a method of encoding a moving picture, the method including a first encoding operation of performing first pass encoding on an input video image; and a second encoding operation of receiving first through Nth groups of picture (GOPs) (where N is a positive integer equal to or greater than 2) from the first pass encoder and for encoding the first through Nth GOPs, respectively, wherein, in the second encoding operation, encoding is performed at a 1/N speed, and results obtained by encoding the first through Nth GOPs are transmitted as feedback to the first encoding operation.

The first encoding operation may include transmitting each GOP of the first GOP through Nth GOP and a target bit of each frame to the first through Nth processors.

The first encoding operation may include transmitting a target quantization parameter (QP) of an initial I frame of each GOP of the first GOP through Nth GOP to the first through Nth processors.

The method may further include transmitting a target buffer level of the first GOP through Nth GOP.

The method may further include generating encoding streams obtained by encoding the first GOP through Nth GOP as a single stream.

The first encoding operation or the second encoding operation may include performing encoding while moving sliding windows within a range of each of the first GOP through Nth GOP.

The first encoding operation may include calculating complexity of a YUV image of the input video image, calculating a target bit and a target quantization parameter (QP) by using the complexity, and transmitting the calculated complexity, the target bit, and the target QP to the second encoding operation.

The second encoding operation may include performs encoding by using the complexity, the target bit, and the target QP, which are transmitted in the first encoding operation, and transmitting complexity, an actually used bit, and an actual QP, which are calculated according to the encoding result, as feedback to the first encoding operation.

The first encoding operation may include compensating the complexity, the target bit, and the target QP by using the complexity, the actually used bit, and the actual QP, which are transmitted as feedback from the second encoding operation.

According to another aspect of the present invention, there is provided a non-transitory computer readable recording medium having recorded thereon a program for executing the above-described method.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a conventional apparatus for encoding a moving picture according to H.264;

FIG. 2 is an apparatus for encoding a moving picture, according to an embodiment of the present invention;

FIG. 3 is a diagram for explaining an operation of the apparatus of FIG. 2, according to an embodiment of the present invention.

FIG. 4 is a schematic diagram of an apparatus for encoding a moving picture, according to another embodiment of the present invention;

FIG. 5 is a diagram for describing an encoding operation of the apparatus of FIG. 4; and

FIG. 6 is a flowchart for describing a method of encoding a moving picture, according to an embodiment of the present invention.

### DETAILED DESCRIPTION OF THE INVENTION

The present invention will now be described more fully with reference to the accompanying drawings, in which exemplary embodiments of the invention are shown. Only techniques and structures necessary for understanding the present invention will be described and other techniques or structures which may unnecessarily make the present invention unclear will not be described.

The terms and words which are used in the present specification and the appended claims should not be construed as being confined to common meanings or dictionary meanings but should be construed as meanings and concepts matching the technical spirit of the present invention in order to describe the present invention in the best fashion.

A general video codec compresses/encodes video data by removing spatial redundancy and temporal redundancy in an image and displays the video data as a bitstream with a much shorter length. For example, a video codec removes spatial redundancy in an image by removing through discrete cosine transformation (DCT) and quantization a high frequency component, which accounts for a large part of the image data and to which human eyes are not sensitive. Also, the video codec removes temporal redundancy, that is, a similarity between frames, by detecting the similarity between the frames and transmitting motion vector information and an error component generated when a motion is expressed with a motion vector, without transmitting data of a similar portion. Also, the video codec reduces the amount of transmitted data by using a variable-length code (VLC) which maps a short code value to a bit string that frequently occurs.

The video codec processes data in units of blocks including a plurality of pixels, for example, in units of macroblocks (MBs) when compressing/encoding and decoding an image. For example, when compressing/encoding an image, the video codec performs a series of steps such as DCT and quantization in units of blocks. However, when the compressed/encoded image that has gone through these steps is reconstructed, distortion due to blocking is inevitably caused. Here, blocking refers to visually objectionable artificial frontiers between blocks in a reconstructed image, which occur due to loss of portions/pixels of an input image during the quantization or a pixel value difference between adjacent blocks around a block boundary.

Accordingly, in order to prevent distortion due to blocking during compression/encoding or decoding of an image, a deblocking filter is used. The deblocking filter may improve the quality of a reconstructed image by smoothing a boundary between macroblocks to be decoded. A frame image processed by the deblocking filter is used for motion compensated prediction of a future frame or is transmitted to a display device to be reproduced.

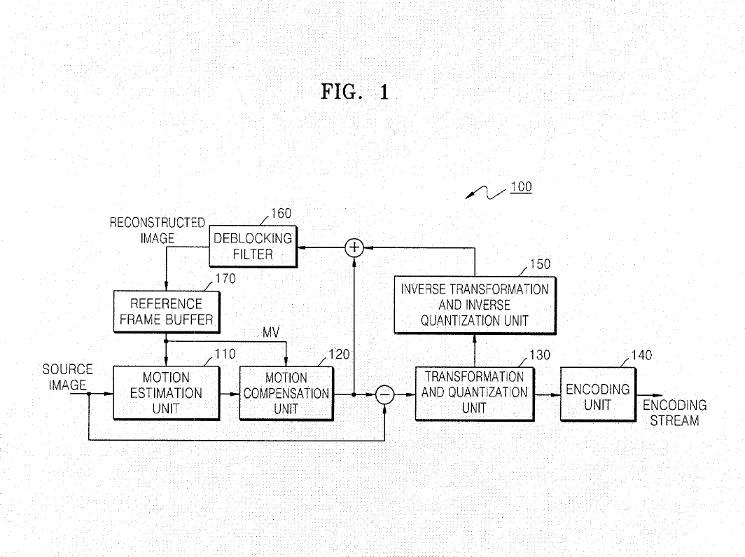

FIG. 1 is a block diagram of a conventional apparatus 100 for encoding a moving picture.

Referring to FIG. 1, the conventional apparatus 100 includes a motion estimation unit 110, a motion compensation unit 120, a transformation and quantization unit 130, an encoding unit 140, an inverse transformation and inverse quantization unit 150, a deblocking filter 160, and a reference frame buffer 170. Here, the term ‘apparatus for encoding a moving picture’ is not construed as being confined, and examples of the apparatus for encoding the moving picture include a moving picture encoder, a video encoder, and a video codec. Although an explanation is provided based on H.264, which is a video coding standard, the present invention is not limited thereto. Also, a source image input to the conventional apparatus 100 is processed in units of macroblocks, and each of the macroblocks may include 16×16 luminance samples, and 8×8Cb and 8×8Cr related chrominance samples. However, the present invention is not limited to the number of pixels included in the macroblocks. In addition, the deblocking filter 160 may be excluded according to the characteristics of an encoding apparatus.

The motion estimation unit 110 searches for a block that is most similar to a source image.

The motion compensation unit 120 reads a portion indicated by a motion vector in the reference frame buffer 170. This process is called motion compensation. A previously encoded frame is stored in the reference frame buffer 170.

The transformation and quantization unit 130 transforms and quantizes a difference between the source image and a motion compensated image. The transformation may be performed by using DCT.

The encoding unit 140 entropy encodes a coefficient of each of the macroblocks, a motion vector, and related header information and outputs a compressed stream. The entropy encoding may be performed by using VLC.

The inverse transformation and inverse quantization unit 150 inversely transforms and inversely quantizes the transformed and quantized difference to produce a predicted error. The predicted error is added to the motion compensated image, and the deblocking filter 160 generates a reconstructed image. The reconstructed image is input to the reference frame buffer 170 and is used as a reference image of subsequent input source images. The deblocking filter 160 is applied to each decoded macroblock in order to reduce distortion due to blocking. On an encoder side, the deblocking filter 160 is used before a macroblock is reconstructed and stored for future prediction. On a decoder side, the deblocking filter 160 is used after a macroblock is reconstructed and inverse transformation is performed before display or transmission. The deblocking filter 160 improves the quality of a decoded frame by smoothing edges of a block. A filtered image may be used for motion compensated prediction of a future frame. Since the filtered image is reconstructed to be more similar to an original frame than a non-filtered image having blocking, compression performance is improved.

The aforesaid encoding and reconstructed image generation may be performed according to MPEG-4, MPEG-2, or H.263, rather than according to H.264.

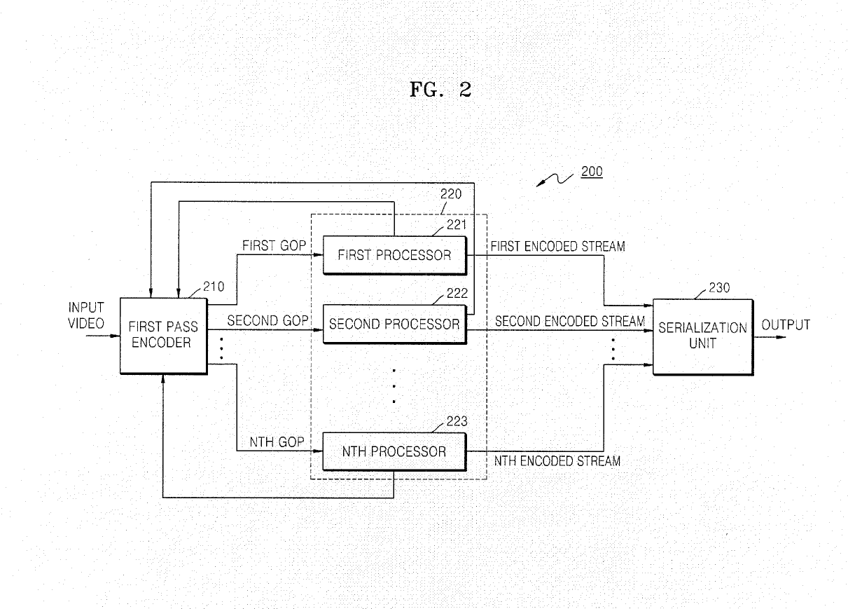

FIG. 2 is an apparatus 200 for encoding a moving picture, according to an embodiment of the present invention.

Referring to FIG. 2, the apparatus 200 includes a first pass encoder 210, a second pass encoder 220 including a first processor 221, a second processor 222, through an Nth processor 223, and a serialization unit 230. Here, N may be a positive integer that is equal to or greater than 2 and may be determined according to the performance and specifications of the apparatus 200. The first pass encoder 210 of the apparatus 200 performs first pass encoding on an input video signal. The first pass encoding is not complete encoding and may use a low-cost second pass encoding method.

The first pass encoding divides the input video signal into N group of picture (GOP) units and maps a bit for encoding each GOP unit. In addition, the first encoding maps a quantization parameter (QP) for an initial I frame of each GOP and predicts a buffer level about a video buffer of a decoder. In MPEG 2/4, frames between an I frame and a next I frame is defined as a single group, that is, a GOP. However, in H.264, frames between an IDR frame and a next IDR frame is defined as a group, that is, a GOP. In most encoders, an interval between an IDR and a next IDR may be fixed so that all GOPs may have the same number of frames.

The second pass encoder 220 receives the GOPs from the first pass encoder 210 and encodes the GOPs. The second pass encoder 220 may include the first processor 221, the second processor 222, through the Nth processor 223, but the number of processors in the second pass encoder 220 is not limited. Each of the first processor 221, the second processor 222, through the Nth processor 223 performs encoding at a 1/N speed obtained by multiplying a real time encoding time by 1/N and transmits the encoding result as feedback to the first pass encoder 210. In this case, the 1/N speed is obtained by multiplying the real time encoding time by 1/N. Thus, when three processors are used, each processor performs encoding at a speed of ⅓ the real time encoding time.

The first pass encoder 210 inputs a YUV image signal that is input to each of the first processor 221, the second processor 222, through the Nth processor 223 to the second pass encoder 220 in units of GOPs. In this case, the YUV image signal is divided into first through Nth GOPs and the first through Nth processors 221 through 223. In this case, in each of first through Nth GOPs, arrangements of I pictures, P pictures, and B picture may be the same or different. An I picture is related to spatial repetition. P and B pictures are related to temporal repetition. That is, each of first through Nth GOPs may have various structures. For example, 15 frames with an order of I_BB_P_BB_P_BB_P_BB_P_BB may constitute a single GOP or 12 frames may constitute a single GOP. A component ratio of I, P, and B frames of a GOP structure may be determined according to characteristics of a video stream, an expected bandwidth of an output stream, and the like. A time taken to perform encoding is also a factor for determining the component ratio. For example, when streams are transmitted in real time, resources used for encoding are limited, and it takes 3 times more than a period of time for encoding a stream containing I pictures only to encode a stream containing a large number of B pictures

The first through Nth processors 221 through 223 encode the first through Nth GOPs transmitted from the first pass encoder 210 and output first through Nth encoding streams. Here, the first through Nth processors 221 through 223 perform encoding in parallel on a single GOP that is simultaneously transmitted. In addition, an encoding result of each of the first through Nth processors 221 through 223 is transmitted back to the first pass encoder 210. The first pass encoder 210 performs the first pass encoding on a next video input by using the transmitted encoding result.

The serialization unit 230 generates and outputs the first through Nth encoding streams as a single stream.

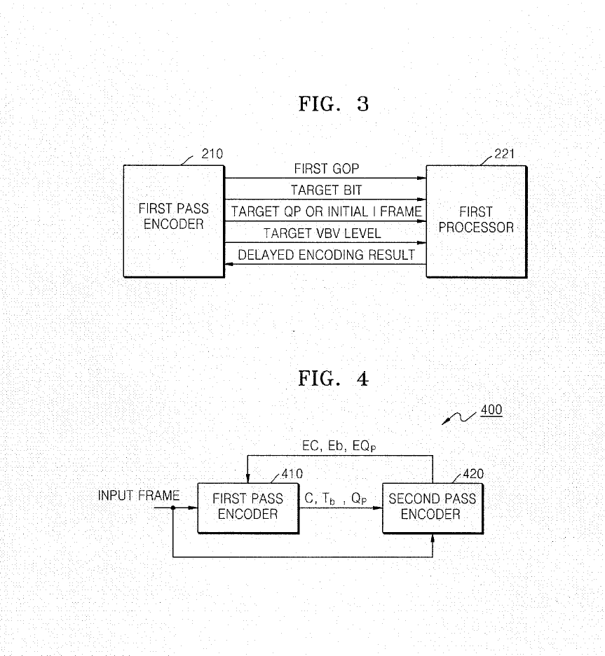

FIG. 3 is a diagram for explaining an operation of the apparatus 200 of FIG. 2, according to an embodiment of the present invention.

FIG. 3 shows the first pass encoder 210 and the first processor 221. The first pass encoder 210 transmits a first GOP, a target bit about the first GOP, a target QP about an initial I frame in the first GOP, and a target video beffer verification (VBV) level to the first processor 221.

The first pass encoder 210 performs inter/intra prediction on input frames so as to obtain complexity of each frame. When the complexity of each frame is obtained, a target bit number required for each frame is calculated by using a total bit number that is mapped according to the complexity. In addition, a target QP is calculated according to Equation 1 below.

Target QP=f(complexity,target bits) (1)

Here, f(complexity, target bits) is used to calculate a QP required when a target bit corresponding to complexity is used in a frame. In addition, a QP may be predicted with reference to a lookup table through a test while there is no feedback transmitted from the first processor 221.

When there is feedback transmitted from the first processor 221, the first pass encoder 210 corrects the target QP according to Equation 2 below.

Target QP=f(complexity,complexity_{—}f,QP,QP_{—}f,target bits,target bits_{—}f) (2)

The first pass encoder 210 predicts a VBV level when it is assumed that encoding is performed according to the encoding result that is transmitted as feedback from the first processor 221, that is, a target bit. For example, when a GOP is started, if predicted or provided start VBV and last VBV are transmitted to the first processor 221, the first processor 221 performs encoding within the predicted VBV in reality so as to reduce as much as possible an error between a predicted value and a real value

When a GOP is started, the target QP is used to maintain continuity of an image quality between GOPs. That is, when a QP difference between a last frame of a previous GOP and a first frame of a next GOP is excessively increased, since the QP difference may seriously affect the image quality, encoding is performed on the first frame by using the target QP when an encoder is started.

In this case, when the encoding result is adjacent to a target bit number, a QP value is corrected and encoding is performed again. However, when a QP value satisfying a target bit number is different from a target QP value by a predetermined value or more, a QP value is not changed any more.

The first processor 221 encodes the first GOP by using the transmitted bit, the QP of the I frame, and the VBV level. The first processor 221 encodes the first GOP in units of macroblocks by mapping a bit amount of the transmitted GOP. The first processor 221 receives a QP of an initial I frame in the transmitted GOP and performs quantization. When the QP is large during the quantization, since a range of the quantized value is small, a difference between the quantized value and an original signal value is high in spite of high compression performance, thereby obtaining bad image quality. On the other hand, when the QP is small, quantized values are adjacent to the original signal value. However, since a range of the quantized value is large, compression performance is not good. Thus, quantization is performed based on a QP of an initial I frame of a corresponding GOP transmitted from the first pass encoder 210.

In addition, when the first processor 221 encodes the first GOP, the first processor 221 needs to check a buffer level in which the video buffer of the decoder begins not to overrun or underrun. To this end, the first processor 221 performs the encoding with reference to the VBV transmitted from the first pass encoder 210.

The first pass encoder 210 maps a bit for each respective frame of the first GOP while performing the first pass encoding and measures the VBD level in the last frame of the first GOP.

The first pass encoder 210 predicts a target QP based on the result of the first pass encoding. In addition, the first processor 221 may perform encoding based on GOP and may transmit the encoding result as feedback to the first pass encoder 210 so that the target QP may be more correctly predicted.

Here, information transmitted as feedback from the first processor 221 to the first pass encoder 210 includes a QP that is actually used for the first processor 221 to encode a GOP and actual encoding complexity of a bit number that is actually used. In addition, the information is used by the first pass encoder 210 to predict the target QP and the target bit number.

In order for the first pass encoder 210 to predict complexity of an image, the complexity is compensated according to Equation 3 below.

Compensated complexity=f(input complexity,feedback complexity) (3)

In this case, complexity of a current input image is compensated by using a relationship between complexity of a previous input image and complexity as feedback transmitted from the first processor 221.

In addition, a compensated target bit number is determined according to a function of compensated complexity and feedback target bit number. Equation 1 is corrected to Equation 4 below.

Target QP=f(compensated complexity,compensated target bit number,feedback QP) (4)

In order to increase accuracy of compensation performed in the first pass encoder 210, information containing intra block count or zero motion vector count may be transmitted as feedback so as to be used as factors of the above functions. Here, the intra block count refers to the number of blocks determined as intra blocks, but not blocks found by motion. As transition or motion is very quickly performed, the number of intra blocks is increased. The zero motion vector count refers to the number of blocks with a motion vector value of 0 and indicates a degree by which an image is moved based on a previous frame.

Based on the information, the reason why the prediction result of the first pass encoder 210 is different from the result of the first processor 221 may be obtained. The reason is reflected to the next prediction in the first pass encoder 210, thereby increasing efficiency of the first pass encoding.

Since the first processor 221 performs encoding at the 1/N speed that is slower than real time, feedback from the first processor 221 is delayed. The first pass encoder 210 may include a buffer for buffering previous information in order to use the delayed encoding result.

With reference to FIG. 3, operations of the first pass encoder 210 and the first processor 221 of the apparatus 200 have been described. The above description is also applied to the second through Nth processor 222 through 223 for encoding the second through Nth GOP.

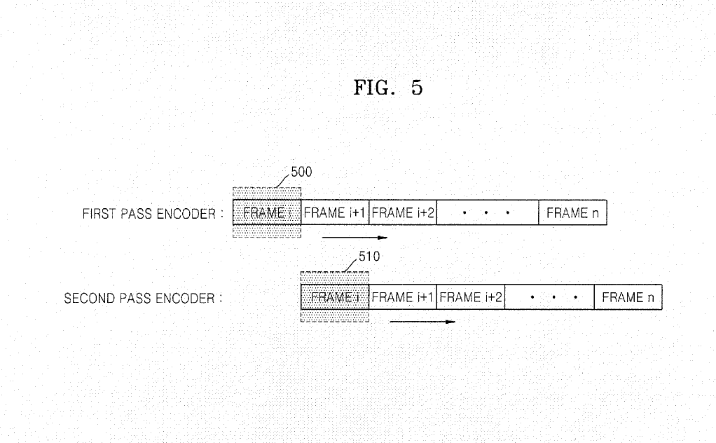

FIG. 4 is a schematic diagram of an apparatus 400 for encoding a moving picture, according to another embodiment of the present invention. FIG. 5 is a diagram for describing an encoding operation of the apparatus 400 of FIG. 4.

FIGS. 4 and 5 show a first pass encoder 410 and a second pass encoder 420. Each of the first pass encoder 410 and the second pass encoder 420 encodes first through nth frame through sliding windows 500 and 510. In this case, the, sliding windows 500 and 510 each have a predetermined size for adjusting a bit rate. For example, in a case of a constant bit rate (CBR), the size may correspond to one second or less and in a case of a variable bit rate (VBR), the size may correspond to 1 second or more. In addition, as the sliding windows 500 and 510 are moved by the determined size, frames belonging to the sliding windows 500 and 510 are encoded.

The first pass encoder 410 performs an operation for obtaining complexity C of input frames. For example, the first pass encoder 410 performs inter/intra prediction that is used in H.264. However, the inter/intra prediction is used for calculating complexity C on YUV of a current input image only, but not for predicting a restored image and a current image or estimating motion. In addition, the first pass encoder 210 calculates a target bit Tb and a Qp by using the calculated complexity C. The target bit Tb may be calculated according to Equation 5 below.

Tb(i)=C(i)*Bw(n)/Cw(n) (5)

In Equation 5, Tb(i) is an ith target bit of a window with a size n, C(i) is complexity of a ith frame, Bw(n) is an available bit of a window with a size n, and Cw(n) is complexity of a window with a size n. When the target bit Tb and the complexity c are calculated, a target QP is calculated according to Equation 1.

The first pass encoder 410 transmits the complexity C of the ith frame, the target bit (Tb), and the target QP to the second pass encoder 420 and then moves the first through nth frames through the sliding windows 500 and 510 to a next frame (i+1).

The second pass encoder 420 encodes the ith frame by using the target bit Tb of the ith frame, which is transmitted from the first pass encoder 410. In addition, the second pass encoder 420 actually encodes the ith frame and then transmits complexity EC of the ith frame, a bit Eb that is used to actually perform encoding, and EQp that is actually encoded as feedback to the first pass encoder 410.

The first pass encoder 410 compensates previous information, that is, the complexity C, the target bit Tb, and the target QP by using the feedback information, that is, the complexity EC of the ith frame, the bit Eb that is used to actually perform encoding, and EQp that is actually encoded.

The first pass encoder 410 calculates an average error rate of complexity by using the complexity EC that is transmitted as feedback from the second pass encoder 420 according to Equation 6.

Average error rate=(sum of C up to now−sum of EC up to now)/sum of C up to now (6)

In addition, complexity C′ that is compensated by using the calculated average error rate is calculated according to Equation 7 below.

Compensated Complexity(C′)=Complexity(C)+average error rate (7)

The first pass encoder 410 calculates a target bit and a target QP by using the compensated complexity (C′). In this case, complexity may be compensated after a predetermined period of time elapses, for example, 1000 frames are accumulated.

In this case, since the first pass encoder 410 and the second pass encoder 420 perform calculation of complexity on different images, that is, the first pass encoder 410 performs prediction or motion estimation on a YUV image and the second pass encoder 420 performs prediction and motion estimation on a current YUV image and a restored image after being encoded, the first pass encoder 410 and the second pass encoder 420 may have different scales. Thus, a sufficient amount of samples for comparing complexities may be obtained and then normalization may be performed.

The first pass encoder 410 calculates a target bit by using the complexity C or the compensated complexity C′ and compensates the target QP according to Equation 2.

So far, a case where the first pass encoding and the second pass encoding are performed on the ith frame has been described. However, as shown in FIG. 5, as the sliding windows 500 and 510 are moved, the first pass encoding and the second pass encoding may be performed on a (i+1)th frame, a (i+2)th frame, through an nth frame by using the same method as the above-described method. In addition, FIG. 5 shows a sliding window in units of frames i, but the present invention is not limited thereto. The sliding window may have a size greater than a size corresponding to a frame I or a size of GOP.

The second pass encoding described with reference to FIGS. 4 and 5 may be applied to the apparatus 200 for performing parallel encoding in units of GOP units, which is shown in FIGS. 2 and 3, but the present invention is not limited thereto. Thus, the second pass encoding may be applied to a general encoder.

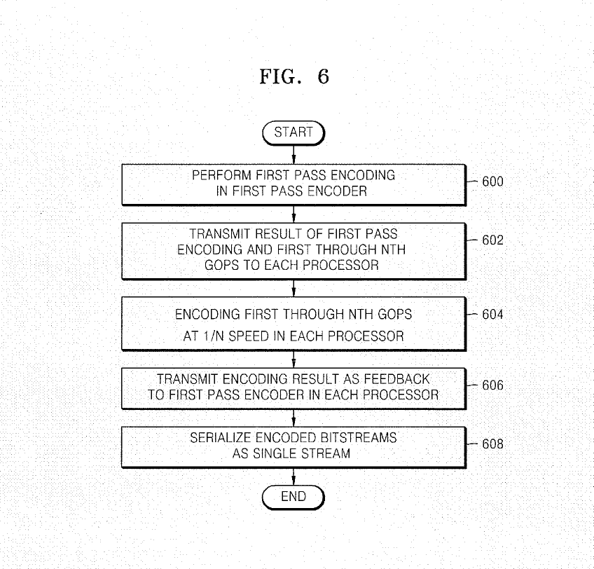

FIG. 6 is a flowchart for describing a method of encoding a moving picture, according to an embodiment of the present invention.

Referring to FIG. 6, in operation 600, a first pass encoder performs first pass encoding. In this case, the first pass encoding does not perform a complete encoding process. Through the first pass encoding, each GOP, a bit of each GOP, an initial I frame of each GOP or a QP of the initial I frame or an intra frame, and share or a VBV level of a video buffer of a decoder are predicted.

In operation 602, the result of the first pass encoding and the first through Nth GOPs are transmitted to each processor. In this case, each processor receives each GOP and the encoding result from the first pass encoder.

In operation 604, each processor performs the first through Nth encoding at the 1/N speed. That is, each processor independently or parallely encodes each GOP at the 1/N speed that is slower than real time.

In operation 606, each processor transmits the encoding result as feedback to the first pass encoder. Each processor transmits the encoding result obtained by encoding each GOP as feedback to the first pass encoder.

In operation 608, encoded bit streams are serialized as a single stream.

An apparatus for encoding a moving picture, according to an embodiment of the present invention, may encode video data with high resolution in parallel without requiring communication between processors that are complex and are sensitive to time.

The apparatus described herein may include a processor, a memory for storing and executing program data, a permanent storage unit such as a disk drive, a communication port for handling communications with external devices, and a user interface device such as a touch panel, keys, and buttons. The methods may be implemented as software modules or algorithms, and may be stored as program instructions or computer-readable codes executable by the processor on a computer-readable recording medium. Here, examples of the computer-readable recording medium include a magnetic storage medium (e.g., a read-only memory (ROM), a random-access memory (RAM), a floppy disk, or a hard disk) and an optical reading medium (e.g., a compact disk (CD)-ROM or a digital versatile disk (DVD)). The computer-readable recording medium may be distributed over network-coupled computer systems so that the computer-readable code may be stored and executed in a distributed fashion. The computer-readable recording medium may be read by the computer, stored in the memory, and executed by the processor.

All references including publications, patent applications, and patents cited herein are incorporated herein in their entireties by reference. For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional blocks and various processing steps. Such functional blocks may be realized by any number of hardware or/and software components configured to perform specific functions. For example, the present invention may employ various integrated circuit components, e.g., memory elements, processing elements, logic elements, and look-up tables, and the like, which may carry out a variety of functions under the control of one or more microprocessors or other control devices. Similarly, where the elements of the present invention are implemented using software programming or software elements, the present invention may be implemented with any programming or scripting language, such as C, C++, Java, or assembly, with various algorithms being implemented with any combination of data structures, objects, processes, routines, or other programming elements. Functional aspects may be implemented in algorithms that execute on one or more processors. Furthermore, the present invention could employ any number of conventional techniques for electronics configuration, signal processing and/or control, data processing, and the like. The terms “mechanism”, “element”, “means”, and “configuration” are broadly used, and are not limited to mechanical and physical embodiments, but can include software routines in connection with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections, may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those skilled in this art without departing from the spirit and scope of the present invention.

What is claimed is:

1. An apparatus for encoding a moving picture, the apparatus comprising:
a first pass encoder for performing first pass encoding on an input video image; and
a second pass encoder comprising first through Nth processors (where N is a positive integer equal to or greater than 2) for receiving first through Nth groups of picture (GOPs) from the first pass encoder and for encoding the first through Nth GOPs, respectively,
wherein the first through Nth processors perform encoding at a 1/N speed and transmit results obtained by encoding the first through Nth GOPs as feedback to the first pass encoder, respectively.

2. The apparatus of claim 1, wherein the first pass encoder transmits each GOP of the first GOP through Nth GOP and a target bit of each frame to the first through Nth processors.

3. The apparatus of claim 2, wherein a target quantization parameter (QP) of an initial I frame of each GOP of the first GOP through Nth GOP is transmitted to the first through Nth processors.

4. The apparatus of claim 3, wherein a target buffer level of the first GOP through Nth GOP is transmitted to the first through Nth processors.

5. The apparatus of claim 1, further comprising a serialization unit for generating encoding streams obtained by encoding the first GOP through Nth GOP as a single stream.

6. The apparatus of claim 1, wherein the first pass encoder further comprises buffers for storing delayed encoding results that are transmitted from the first through Nth processors.

7. The apparatus of claim 1, wherein the first through Nth processors perform encoding in parallel on the first through Nth GOPs at the 1/N speed.

8. The apparatus of claim 1, wherein the first pass encoder or the second pass encoder perform encoding while moving sliding windows within a range of each of the first GOP through Nth GOP.

9. The apparatus of claim 1, wherein the first pass encoder calculates complexity of a YUV image of the input video image, calculates a target bit and a target quantization parameter (QP) by using the complexity, and transmits the calculated complexity, the target bit, and the target QP to the second pass encoder.

10. The apparatus of claim 9, wherein the second pass encoder performs encoding by using the complexity, the target bit, and the target QP, which are transmitted from the first pass encoder, and transmits complexity, an actually used bit, and an actual QP, which are calculated according to the encoding result, as feedback to the first pass encoder.

11. The apparatus of claim 10, wherein the first pass encoder compensates the complexity, the target bit, and the target QP by using the complexity, the actually used bit, and the actual QP, which are transmitted as feedback from the second pass encoder.

12. A method of encoding a moving picture, the method comprising:
a first encoding operation of performing first pass encoding on an input video image; and
a second encoding operation of receiving first through Nth groups of picture (GOPs) (where N is a positive integer equal to or greater than 2) from the first pass encoder and for encoding the first through Nth GOPs, respectively,
wherein, in the second encoding operation, encoding is performed at a 1/N speed, and results obtained by encoding the first through Nth GOPs are transmitted as feedback to the first encoding operation.

13. The method of claim 12, wherein the first encoding operation comprises transmitting each GOP of the first GOP through Nth GOP and a target bit of each frame to the first through Nth processors.

14. The method of claim 13, wherein the first encoding operation comprises transmitting a target quantization parameter (QP) of an initial I frame of each GOP of the first GOP through Nth GOP to the first through Nth processors.

15. The method of claim 14, further comprising transmitting a target buffer level of the first GOP through Nth GOP.

16. The method of claim 12, further comprising generating encoding streams obtained by encoding the first GOP through Nth GOP as a single stream.

17. The method of claim 12, wherein the first encoding operation or the second encoding operation comprises performing encoding while moving sliding windows within a range of each of the first GOP through Nth GOP.

18. The method of claim 12, wherein the first encoding operation comprises calculating complexity of a YUV image of the input video image, calculating a target bit and a target quantization parameter (QP) by using the complexity, and transmitting the calculated complexity, the target bit, and the target QP to the second encoding operation.

19. The method of claim 18, wherein the second encoding operation comprises performs encoding by using the complexity, the target bit, and the target QP, which are transmitted in the first encoding operation, and transmitting complexity, an actually used bit, and an actual QP, which are calculated according to the encoding result, as feedback to the first encoding operation.

20. A non-transitory computer readable recording medium having recorded thereon a program for executing the method of claim 12.
